(19) United States
(12) Patent Application Publication
(10) Pub. No.: US 2018/0158052 A1
(43) Pub. Date: Jun. 7, 2018

(54) ASYNCHRONOUS CRYPTOGRAM-BASED AUTHENTICATION PROCESSES

(71) Applicant: The Toronto-Dominion Bank, Toronto (CA)

(72) Inventors: Dean C.N. TSERETOPOULOS, Toronto (CA); Paul Mon-Wah Chan, Toronto (CA); John Jong Suk Lee, Toronto (CA)

(21) Appl. No.: 15/366,546

(22) Filed: Dec. 1, 2016

(51) Int. Cl. G06Q 20/38; H04L 9/32; G06Q 30/00

(52) U.S. Cl. CPC G06Q 20/3829; H04L 9/3247; G06Q 2220/00; G06Q 30/0185; G06Q 20/38215

(57) ABSTRACT

The disclosed embodiments include computer-implemented devices and processes that asynchronously authenticate data. For example, a network-connected device may obtain data identifying a product, and obtain cryptographic data from an executed application through a programmatic interface. The cryptographic data may be generated by a first computer system in response to a verification of authentication credentials, and the cryptographic data may include a digital signature of the first computer system. The device may also transmit the product data and the cryptographic data to a second computer system, which may be configured to validate the cryptographic data and establish an authenticity of the product data. The device may receive data from the second computer system that confirms the authenticity of the product data, and in response to the received confirmation data, perform an operation involving the product data.

### TECHNICAL FIELD

The disclosed embodiments generally relate to computer-implemented systems and processes that asynchronously authenticate data based on obtained cryptograms.

### BACKGROUND

Today, payment systems and related technologies continuously evolve in response to advances in payment instruments, such as the ongoing transition from physical transaction cards to digital payment instruments maintained on mobile devices by digital wallets. These digital wallets may include third-party digital wallets unrelated to issuers of the digital payment instruments or to payment-rail systems that settle transactions involving the digital payment instruments, and security architectures implemented by the issuers and payment-rail systems may delay the provisioning of new digital payment instruments to these third-party digital wallets.

### SUMMARY

The disclosed embodiments may include computer-implemented systems, devices and processes that authenticate data, which may be obtained by a first application executed by a device, based on cryptographic data obtained from a second application executed by the device. In certain instances, and in response to a request received from the first application through a corresponding programmatic interface, the second application may poll a network-connected computer system to obtain the cryptographic data, which may be passed to the first application through the programmatic interface. The first application, when executed by the device, may cause the device to transmit the cryptographic data to an additional computer system as a portion of a request to authenticate the data obtained by the first application, and based on a validation of the cryptographic data, the additional computer system may provide a confirmation of the authenticated data to the first application, which may perform operations involving the authenticated data and in accordance with the received confirmation

In certain embodiments, a device may include a communications module, a storage unit storing instructions, and at least one processor coupled to the storage unit and the communications module. The at least processor may be configured to execute the instructions to obtain data identifying a product, and in response to the obtained data, request cryptographic data from an application program executed by the at least one processor. In one aspect, the request may be provided to the executed application program through a programmatic interface. The at least processor may also be configured to execute the instructions to receive the cryptographic data from the executed application program through the programmatic interface. The cryptographic data may, in additional aspects, be generated in response to a verification of authentication credentials associated with the device. The at least processor may be further configured to execute the instructions to transmit, through the communications module, a request to authenticate the product data to a first computer system. In other aspects, the request may include the product data and the cryptographic data, and the first computer system may be configured to validate the cryptographic data and establish an authenticity of the product data. The at least processor may be configured to execute the instructions to receive, through the communications module, data from the first computer system that confirms the authenticity of the product data, and in response to the data received from the first computer system, perform an operation involving the product data.

Additionally, in some embodiments, a computer-implemented method may include the steps of obtaining, by at least one processor, data identifying a product, and in response to the obtained data, requesting, by the at least one processor, cryptographic data from an application program executed by the at least one processor. In one aspect, the request may be provided to the executed application program through a programmatic interface. The computer-implemented method may also receive, by the at least one processor, the cryptographic data from the executed application program through the programmatic interface. The cryptographic data may, in additional aspects, be generated in response to a verification of authentication credentials associated with the device. The computer-implemented method may also include transmitting, through a communications module, and by the at least one processor, a request to authenticate the product data to a first computer system. In other aspects, the request may include the product data and the cryptographic data, and the first computer system may be configured to validate the cryptographic data and establish an authenticity of the product data. The computer-implemented method may receive, through the communications module, and by the at least one processor, data from the first computer system that confirms the authenticity of the product data, and in response to the data received from the first computer system, perform, by the at least one processor, an operation involving the product data.

In other embodiments, a device may include a communications module, a storage unit storing instructions, and at least one processor coupled to the storage unit and the communications module. The at least processor may be configured to execute the instructions to receive, through a programmatic interface, a request for cryptographic data from an application program executed by the at least one processor, and perform operations that verify authentication credentials associated with the device. In response to the verification of the authentication credentials, the at least processor may also be configured to execute the instructions to obtain cryptographic comprising a digital signature of a first computer system, and provide the cryptographic data to the executed application program through the programmatic interface. In some aspects, the executed application program may cause the device to transmit the cryptographic data to a second computer system as a request to authenticate data identifying the product, and the second computer system may be configured to validate the cryptographic data and establish an authenticity of the product data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIGS. 2A and 2B are diagrams illustrating portions of an exemplary computing environment, consistent with the disclosed embodiments.

FIG. 3 is a flowchart of an exemplary process in-band process for authenticating product data based on obtained cryptographic data, in accordance with the disclosed embodiments.

FIG. 4 is a flowchart of an exemplary process of obtaining cryptographic data associated with an issuer of product data, in accordance with the disclosed embodiments.

### DETAILED DESCRIPTION

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the described subject matter.

This specification describes exemplary computer-implemented processes that authenticate data identifying a product, which may be obtained by a first application executed by a device, based on cryptographic data obtained from a second application executed by the device. In certain instances, as described below, the second application program may be associated with an issuer of the data, and in response to a request received from the first application through a corresponding programmatic interface, the second application may poll a network-connected computer system associated with the issuer to obtain the cryptographic data, which may be passed to the first application through the programmatic interface.

The cryptographic data may, in some aspects, include a digital signature generated by a computer system associated with the issuer (e.g., an issuer computing system) using a secure cryptographic key maintained by and accessible to not only the issuer computer system, but also to an additional network-connected computer system capable of authenticating the product data for use in operations performed by the first application. In some aspects, the first application, when executed by the device, may cause the device to transmit the cryptographic data to the additional computer system as a portion of a request to authenticate the product data, and based on a validation of that cryptographic data, the additional computer system may provide a confirmation of the validated product data to the first application, which may perform operations involving the approved product data and in accordance with the received confirmation.

In some aspects, the first application may include a payment service application that, when executed by the device, performs operations to establish and maintain a digital wallet provisioned within one or more digital payment instruments usable in transactions involving the digital wallet. Examples of these digital payment instruments may include, but are not limited to, credit and debit card accounts held by a user of the device and issued by one or more financial institutions (e.g., issuers), checking or savings accounts held by the user, electronic funds transfers (e.g., e-transfers), and units of one or more digital currencies held by the customer in one or more corresponding accounts (e.g., units of Bitcoin™, Litecoin™, etc.). Additionally, in some aspects, the digital payment instruments may also be associated with one or more payment networks or payment-rail systems, which may process and settle transactions involving corresponding ones of the digital payment instruments.

For example, the user may hold a Visa™ credit card issued by a corresponding financial institution and associated with a corresponding Visa™ payment network, which settles transactions involving the Visa™ credit card and merchants affiliated with the payment network. To provision the Visa™ credit card for use in transactions involving the mobile wallet, the executed payment service application may receive account data that identifies and specifies the Visa™ credit card, such as an account number, an expiration date, a card-security code (CSC), and a name and address of an account holder, and may perform operations that transmit portions of the received account data to a payment-network computer system associated with the Visa™ payment network (e.g., the additional computer system described above), which may authenticate the received account data and approve the Visa™ credit card for use in transactions settled by the Visa™ payment network. In some aspects, upon receipt of data confirming the authentication and approval of the account data, the executed payment service application may perform operations that tokenize the received account data and provision the Visa™ credit card to the mobile wallet.

In one instance, the payment service application may be associated with, or may be provided to the device by, computer systems associated with the issuer of the Visa™ credit card or with the Visa™ payment network, and the payment service application may provide, to the payment-network computer system, cryptographic data (e.g., encrypted tokens, cryptograms, etc.) that enables the payment-network computer system to verify an identity of the payment service application (and/or the device) and establish a level of trust with the payment service application sufficient to authenticate the received account data. For example, the cryptographic data may include, but is not limited to, an encrypted payment instrument (EPI), which may incorporate a digital signature generated by the payment-network computer system using a secure cryptographic key known to both the payment-network computer system and the issuer computer system. Based on the received cryptographic data (e.g., the EPI), the payment-network computer system may provide a decision regarding the approval of the new payment instrument (e.g., the Visa™ credit card) to the payment service application in real time based on locally accessible data.

In other instances, and consistent with the disclosed embodiments, the payment service application may be provided by a third-party entity that is unrelated to the issuer of the Visa™ credit card or to Visa™ payment network. For example, the payment service application, when executed by the device, may establish and maintain a third-party digital wallet (e.g., a digital wallet established by Google Pay™ or other third-party applications) provisioned with digital payment instruments issued by various financial institutions and associated with various payment networks and payment rails.

Due to the lack of association between the payment service application and the issuer Visa™ credit card or the corresponding payment network, the transmitted account data may not include cryptographic data (e.g., the EPI) that enables the payment-network computer system to establish the level of trust with the payment service application sufficient to provide a real-time approval of the account data. Instead, the payment-network computer system may implement one or more “out-of-band” authentication processes that route the received account data to a computer system maintained by the issuer of the Visa™ credit card for authentication. The payment-network computer system may, in some instances, receive a confirmation of the authenticated account data from the issuer computer system, and may route the confirmation back to the payment service application, which perform operations that provision the Visa™ credit card to the mobile wallet for use in transactions.

In some aspects, one or more of the out-of-band authentication processes, as described above, may result in significant delays in the provisioning of a new payment instrument into the third-party digital wallet maintained by the payment service application. For example, the issuer computer system may batch together authentication requests from payment-network systems and respond to the batched authentication requests on a daily basis or in accordance with a predetermined schedule (e.g., every two days, etc.). Due to the batch processing implemented by the issuer computer systems, the third-party digital wallet may include digital payment instruments that are fully provisioned and available for immediate use, and other digital payment instruments that await approval from the corresponding payment-network computer system and thus, are not provisioned into the third-party mobile wallet for use in transactions.

Further, out-of-band account authentication processes, such as those described above, reduce the computational efficiency of both the payment-network computer system, which may cache the account data received from the executed payment service application for subsequent approval based on batched confirmations from the issuer systems, and the issuer system itself, which may devote computational resources to authenticating account data in response to requests generated by each application that provisions a digital payment instrument to a third-party digital wallet. In additional aspects, the repeated exchanges of data between the payment service application (e.g., as executed by the device), the payment-network computer system, and the issuer system may render these out-of-band authentication processes susceptible to fraudulent activity, e.g., an interception and an unauthorized access to portions of the transmitted account data by malicious parties.

In certain aspects, and as described below, the device, the payment-network computer system, and the issuer computer system may perform processes that asynchronously authenticate account data associated with a digital payment instrument (e.g., as received by the payment service application) based on cryptographic data obtained by a second application executed by the device and associated with an issuer of the digital payment instrument. By way of example, the second application program may correspond to a mobile banking application associated with or provided by the issuer of the Visa™ credit card, and in response to a request received from the executed payment service application through a corresponding programmatic interface, the mobile banking application, when executed by the device, may authenticate the user and obtain, from the issuer computer system, cryptographic data that enables the payment-network computer system to establish secure, trusted communications with the unrelated, payment service application.

The payment service application, when executed by the device, may transmit the cryptographic data to the payment-network computer system as a portion of a request to authenticate the newly received account data, and based on the cryptographic data, the payment-network computer system may identify and establish a level of trust with the executed payment service application sufficient to authenticate the account data directly and without obtaining data from the issuer computer system. Certain of these exemplary computer-implemented processes, which facilitate in-band, asynchronous authentication of account data received by third-party payment service applications, may be implemented in addition to or as an alternate to out-of-band authentication processes in which the payment-network computer system polls the issuer computer system to authenticate the account data.

### I. Exemplary Computing Environments

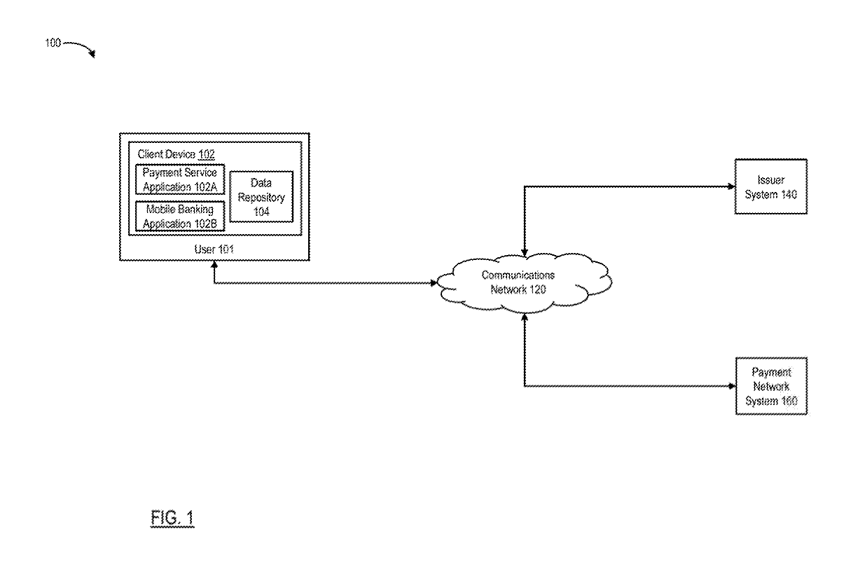

FIG. 1 is a diagram of an exemplary computing environment 100, consistent with certain disclosed embodiments. In some aspects, as illustrated in FIG. 1, environment 100 may include one or more client devices, such as device 102, one or more computer systems associated with issuers of payment instruments, such as issuer system 140, and one or more computer systems associated with and maintained by corresponding payment networks, such as payment-network system 160, which may be interconnected through any appropriate combination of communications networks, such as network 120.

Examples of network 120 include, but are not limited to, a wireless local area network (LAN), e.g., a “Wi-Fi” network, a network utilizing radio-frequency identification (RFID) communication protocols, a Near Field Communication (NFC) network, a wireless Metropolitan Area Network (MAN) connecting multiple wireless LANs, and a wide area network (WAN), e.g., the Internet. Consistent with the disclosed embodiments, network 120 may include the Internet and any publicly accessible network or networks interconnected via one or more communication protocols, including, but not limited to, hypertext transfer protocol (HTTP) and transmission control protocol/internet protocol (TCP/IP). Communications protocols consistent with the disclosed embodiments also include protocols facilitating data transfer using radio frequency identification (RFID) communications and/or NFC. Moreover, network 120 may also include one or more mobile device networks, such as a GSM network or a PCS network, allowing device 102 and other devices to exchange data via applicable communications protocols, including those described herein.

In an embodiment, device 102 may be associated with a user, e.g., user 101, and may correspond to a computing device that includes one or more tangible, non-transitory memories that store data and/or software instructions, and one or more processors configured to execute the software instructions. The one or more tangible, non-transitory memories may, in some aspects, store software applications, application modules, and other elements of code executable by the one or more processors, such as web browsers and other applications provided by or associated with various entities, such as those associated with and that maintain issuer system 140 and payment-network system 160.

For example, and as illustrated in FIG. 1, the one or more tangible, non-transitory memories may store a first application program, such as payment service application 102A, that when executed by the one or more processors, performs operations that establish and maintain a third-party digital wallet provisioned with digital payment instruments held by user 101 and available for use in transactions initiated at point-of-sale (POS) terminals maintained by corresponding merchants. Further, the one or more tangible, non-transitory memories may also store a second application program, such as a mobile banking application 102B, which may be associated with a financial institution that issues a corresponding one of the digital payment instruments provisioned to the third-party digital wallet. In certain aspects, not depicted in FIG. 1, payment service application 102A and mobile banking application 102B may exchange data through one or more programmatic interfaces, such as an application programmatic interface (API) associated with mobile banking application 102B.

In further instances, the one or more tangible, non-transitory memories may also include structured data records that establish a data repository, such as data repository 104. In some aspects, data repository 104 may store data identifying the one or more digital payment instruments provisioned to the third-party digital wallet, such as account numbers, expiration dates, card-security codes (CSCs), issuer identifier numbers (IINs), and/or account-holder names and addresses, and data that uniquely identifies the maintained digital wallet and/or the user 101 (e.g., a digital wallet token and/or a digital wallet address). Additionally, data repository 104 may store cryptographic data that, as described below, enables payment-network system 160 to establish a level of trust with payment service application 102A sufficient to authenticate account data directly and without data obtained from issuer system 140. Data repository 104 may also store data that facilitates a performance of operations by executed mobile banking application 102A, such as one or more authentication credentials of user 101.

Client device 102 may also include one or more interface modules that display information to user 101 and additionally or alternatively, that to allow user 101 to input information to client device 102 (e.g., a keypad, keyboard, pressure-sensitive touchscreen, voice-activated control technologies, or any other type of known input device). Additionally, client device 102 may include a communications module, such as a wireless transceiver device, coupled to the one or more processors and configured by the one or more processors to establish and maintain communications with network 120 using any of a number of communications protocols.

Examples of client device 102 may include, but are not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface module, consistent with disclosed embodiments. In some instances, user 101 may operate client device 102 and may do so to cause client device 102 to perform one or more operations consistent with the disclosed embodiments.

Issuer system 140 and payment-network system 140 may, in some aspects, represent corresponding computer systems configured to execute software instructions (e.g., one or more executable applications or application modules) that perform operations consistent with disclosed embodiments. For example, and as described below, issuer system 140 may perform operations that, in response to a request transmitted from mobile banking application 102B, authenticate an identity of user 101 based on obtained authentication credentials, and further, generate and provide cryptographic data to mobile banking application 1026 that includes a digital signature of issuer system 140. In certain aspects, an as described below, issuer system 140 may generate the digital signature based on a secure cryptographic key shared between issuer system 140 and payment-network system 160, and when provided to payment-network system 160 by device 102 (e.g., in response to an execution of payment service application 102A), the generated cryptographic data may enable payment-network system 160 to identify and establish trust with payment service application 102A. In response to the established trust, payment-network system 160 may perform operations that authenticate account data received from device 102 directly and without data obtained from issuer system 140.

In one instance, issuer and payment-network systems 140 and 160 may include one or more servers and tangible, non-transitory memory devices storing executable code and application modules. Further, the servers may include one or more processor-based computing devices, which may be configured to execute portions of the stored code or application modules to perform operations consistent with the disclosed embodiments, including operations consistent with the exemplary micropayment settlement processes described herein. In other instances, and consistent with the disclosed embodiments, issuer system 140 and/or payment-network system 160 may correspond to a distributed system that may include computing components distributed across one or more networks, such as network 120, or other networks, such as those provided or maintained by cloud-service providers.

### II. Exemplary Computer-Implemented, Cryptogram-Based Processes for Asynchronously Authenticating Product Data

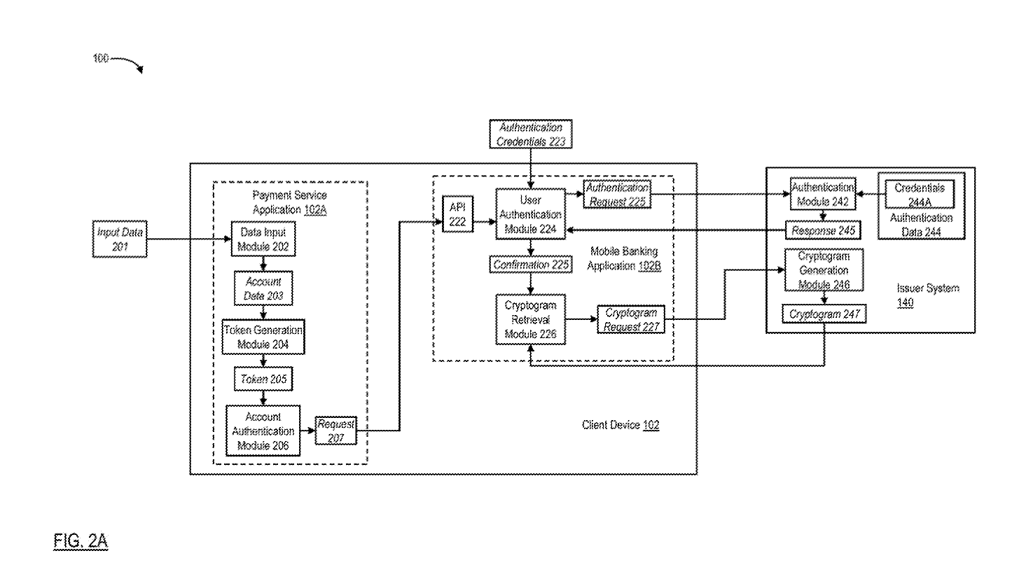

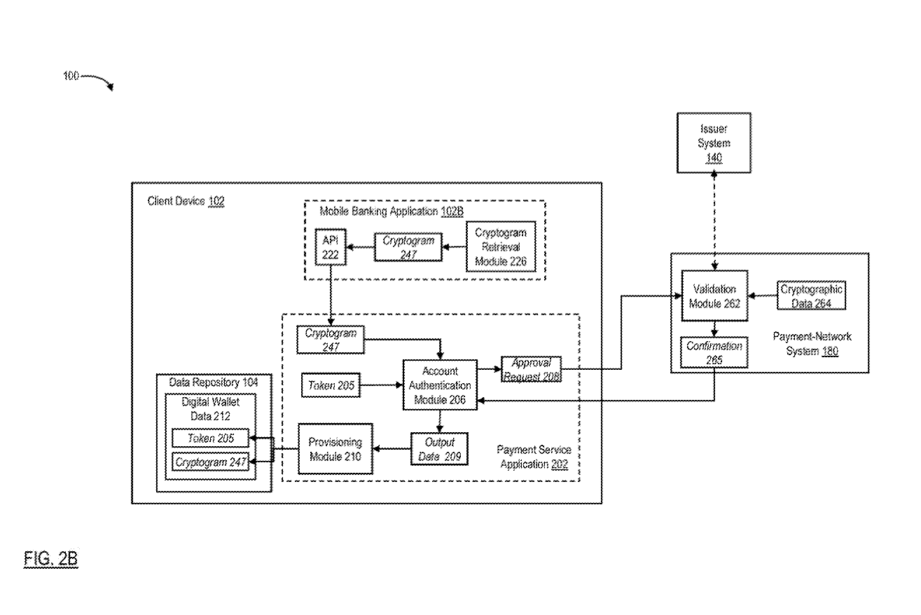

FIGS. 2A and 2B illustrate additional portions of computing environment 100, certain components of which may perform processes that asynchronously authenticate data in accordance with the disclosed embodiments. For example, as illustrated in FIG. 2A, device 102 may store, within one or more tangible, non-transitory memories, a first application program, e.g., payment service application 102A, and a second application program, e.g., mobile banking application 102B. In some aspects, and when executed by device 102, payment service application 102A may perform operations that asynchronously authenticate received or generated product data based on cryptographic data obtained from mobile banking application 102B through a corresponding programmatic interface, such as an application programming interface (API).

For example, payment service application 102A, when executed by device 102, may establish and maintain a third-party digital wallet that includes one or more digital payment instruments held by user 101 and available for use in transactions involving various counterparties (e.g., purchase transaction involving a merchant and initiated through a corresponding POS terminal device, a peer-to-peer (P2P) transaction involving one or more additional users operating devices executing similar payment service applications, etc.). In some aspects, mobile banking application 102B may be associated with or provided by a financial institution that issues one or more of the digital payment instruments included within the third-party digital wallet, and in response to a request received from executed payment service application 102A, and when executed by device 102, mobile banking application 102B may perform operations that cause device 102 to poll a computer system associated with the issuer, e.g., issuer system 140 of FIG. 1, to obtain the cryptographic data, which may be passed to the executed first application through the API.

As described above, the cryptographic data may include a digital signature generated by issuer system 140 using a secure cryptographic key maintained by and accessible to not only issuer system 140, but also to an additional network-connected computer system capable of authenticating the product data for use in operations performed by payment service application 102A, e.g., payment-network system 160 of FIG. 1. In some aspects, executed payment service application 102A may transmit the cryptographic data to payment-network system 160 as a portion of a request to authenticate the product data, and based on a validation of that cryptographic data, the payment-network-system 160 may provide a confirmation of the validated product data to executed payment service application 102A, which may cause device 102 to perform operations involving the approved product data and in accordance with the received confirmation.

In an embodiment, the product data may include account data that identifies and specifies a payment instrument held by user 101, such as a new Visa™ credit card that user 101 intends to include within the third-party digital wallet maintained on device 102 by payment service application 102A. By way of example, the Visa™ credit card may be issued by a financial institution that provides or is associated with mobile banking application 102B, and a payment network associated with payment-network system 160, such as a Visa™ payment rail, may perform operations that process and settle initiated transactions involving the Visa™ credit card. Further, payment service application 102A, when executed by device 102, may obtain portions of the account data identifying and specifying the Visa™ credit card (e.g., as input by user 101 through a corresponding interface module of device 102), and prior to provisioning the new Visa™ credit card within the third-party digital wallet, may perform operations that authenticate the received account data in conjunction with payment-network system 160.

As described above, the third-party digital wallet may be unrelated to the issuer of the Visa™ credit card or to the Visa™ payment rail, and thus, payment service application 102A may be unknown to and untrusted by payment-network system 160. In certain aspects, payment service application 102A, when executed by device 102, may perform any of the exemplary processes described below to authenticate, in real-time and without the delays associated with the out-of-band authentication processes described above, the account data specifying the new Visa™ credit card based on cryptographic data recognized by payment-network system 160 and obtained from mobile banking application 102B through the corresponding API.

Referring back to FIG. 2A, payment service application 102A may, when executed by device 102, perform operations that generate a graphical user interface (GUI), which device 102 may present to user 101 through the corresponding interface module, such as a pressure-sensitive, touchscreen display. By way of example, the presented GUI may prompt user 101 to provide input that identifies a new payment instrument, e.g., the Visa™ credit card held by user 101, for provisioning to the third-party digital wallet, and further, that specifies certain account parameters of that new payment instrument, such as an account number, an expiration date, a card-security code (CSC), and a name and address of an account holder of the Visa™ credit card. In response to the presented GUI, user 101 may provide input data 201 that identifies and specifies the new Visa™ credit card, which device 102 may receive through the corresponding interface module.

In some aspects, a data input module 202 of executed payment service application 102A may receive input data 201, and may perform operations that process input data 201 and extract account data 203 that specifies the credit-card account associated with the new Visa™ credit card. For example, account data 203 may include, but is not limited to, the sixteen-digit account number of the Visa™ credit card, the expiration date of the Visa™ credit card, the three-digit CSC of the Visa™ credit card, and/or the name and address of user 101 (e.g., the account holder of the Visa™ credit card), and data input module 202 may provide account data 203 to a token generation module 204 of executed payment service application 102A.

Token generation module 204 may perform operations that generate a unique digital identifier, e.g., a token 205, that represents portions of account data 201 and facilitates the use of the Visa™ credit card for purchases using the third-party digital wallet. In some instances, token 205 may replace or obscure sensitive portions of account data 201, such as the sixteen-digit account number, the expiration data, and/or the three-digit CSC, with additional data known to or recognizable by issuer system 140 and/or payment-network system 160. Further, in additional instances, token generation module 204 may generate token 205 based on an application, to account data 201, of one or more token generation algorithms appropriate to the underlying payment instrument, e.g., the Visa™ credit card, issuer system 140, and payment-network system 160, such as a token generation algorithm consistent with a Visa Token Service™. Token generation module 204 may provide token 205 to an account authentication module 206 of executed payment service application 102A, which as described below, may perform operations that asynchronously authenticate account data 201 in conjunction with payment-network system 160.

Account authentication module 206 may receive token 205, which represents the credit-card account associated with the Visa™ credit card, and may perform operations that identify one or more applications executed by device 102 and associated with a financial institution that issues the Visa™ credit card. For example, account authentication module 206 may access stored data (e.g., data or metadata stored within one or more tangible, non-transitory memories of device 102) that identifies mobile banking application 102B, and based on the accessed data, establish an association between mobile banking application 102B and the financial institution that issues the Visa™ credit card (i.e., the issuer of the Visa™ credit card).

Further, based on its relationship with issuer, mobile banking application 1026 may, when executed by device 102, perform operations that obtain cryptographic data from issuer system 140 that enables payment-network system 160 to identify and establish a level of trust with payment service application 102A sufficient to authenticate account data 201 directly wand without obtaining data from issuer system 140. In response to the established association, account authentication module 206 may perform operations that generate a request 207 for the cryptographic data, which may be provided to mobile banking application 102B through a corresponding programmatic interface, such as API 222.

In some aspects, mobile banking application 102B may receive request 207 through API 222, and when executed by device 102, may generate a corresponding graphical user interface (GUI) that prompts user 101 to enter one or more appropriate authentication credentials. The one or more authentication credentials may include, but are not limited to, an alpha-numeric login or password assigned to user 101 by mobile banking application 102B and a biometric credential associated with user 101 by mobile banking application 102B, such as a fingerprint. Device 102 may present the generated GUI to user 101 through the corresponding interface module, and in response to the presented GUI, user 101 may input data indicative of the one or more authentication credentials, e.g., authentication credentials 223, to device 102 through the corresponding interface module.

A user authentication module 226 of executed mobile banking application 102B may receive authentication credentials 223, and may perform operations that authenticate an identify of user 101 based on portions of authentication data 223. For example, and as described above, executed mobile banking application 102B may be associated with the financial institution that issues the Visa™ credit card, and in one aspect, may delegate the authentication of user 101 to a computer system associated with that financial institution, such as issuer system 140. Based on the delegation, user authentication module 226 may perform operations that package portions of authentication credentials 223 into an authentication request 225, which device 102 may transmit across network 120 to issuer system 140.

As illustrated in FIG. 2A, an authentication module 242 of issuer system 140 may receive authentication request 225 from device 102, and may perform operations that extract the authentication credentials from authentication request 225. Further, in one aspect, authentication module 242 may access authentication data 244 stored within one or more tangible, non-transitory memories, and may access authentication credentials 244A assigned to user 101 by issuer system 140. Authentication module 242 may perform operations that authenticate the identity of user 101 based on a comparison of the extracted authentication credentials (e.g., from authentication request 225) and assigned authentication credentials, and may generate a response 245 indicative of an outcome of the authentication process, which issuer system 140 may transmit across network 120 to device 102 using any of the communications protocols described herein.

In some aspects, user authentication module 224 of executed mobile banking application 102B may receive response 245, and may perform operations that process response 245 and determine an outcome of the authentication of user 101. For example, if issuer system 140 were to determine that the extracted authentication credentials differ from the assigned authentication credentials, response 245 may include data indicative of a failed authentication of user 101, and user authentication module 224 may perform operations that present a representation of the failed authentication to user 101 through the interface module, e.g., within the GUI described above.

In other instances, if issuer system 140 were to establish a correspondence between the extracted and assigned authentication credentials, response 245 may include data indicative of a successful authentication of user 101, and user authentication module 224 may perform operations that generate a confirmation 225 of the successful authentication, which user authentication module 224 may provide to a cryptogram retrieval module 226 of executed mobile banking application 1026. In some aspects, and in response to the receipt of confirmation 225, cryptogram retrieval module 226 may generate a request 227 for the cryptographic data that enables payment-network system 160 to identify and trust payment service application 102A, and device 102 may transmit request 227 across network 120 to issuer system 140.

Issuer system 140 may receive request 227, and in response to the received request, a cryptogram generation module 246 of issuer system 140 may generate a digitally signed cryptogram, e.g., cryptogram 247, that enables payment-network system 160 to identify and trust payment service application 102A. In one example, the digitally signed cryptogram may correspond to an encrypted payment instrument (EPI), which may incorporate a digital signature generated by issuer system 140 using a secure cryptographic key known to both issuer system 140 and payment-network system 160. The disclosed embodiments are, however, not limited to these examples of digitally signed cryptograms or EPIs, and in other aspects, issuer system 140 may generate any additional or alternate cryptographic data, such as other digitally signed and/or encrypted tokens, that enables payment-network system 160 to identify and trust payment service application 102A. In some instances, issuer system 140 may transmit cryptogram 247 to device 102 across network 120, and cryptogram retrieval module 226 of executed mobile application 102B may receive cryptogram 247 from issuer system 140 and perform operations that provide cryptogram 247 to executed payment service application 102A through API 222.

Referring to FIG. 2B, account authentication module 206 of executed payment service application 102A may receive cryptogram 247 through API 222, and may perform operations that, in conjunction with payment-network system 160, authenticate account data 201 associated with the Visa™ credit card in real-time and prior to provisioning the Visa™ credit card to the third-party digital wallet for use in transactions. For example, as illustrated in FIG. 2B, account authentication module 206 may generate an approval request 208 that includes token 205 and cryptogram 247 (e.g., as received through API 222), and device 102 may transmit approval request 208 across network 120 to payment-network system 160.

Payment-network system 160 may receive approval request 208, and in some aspects, a validation module 262 of payment-network system 160 may perform operations that extract data indicative of cryptogram 247 from request 208, and validate cryptogram 247 based on cryptographic data 264 stored within one or more tangible, non-transitory memories. For example, cryptogram 247 may correspond to an EPI generated by issuer system 140, which may include a digital signature generated by issuer system 140 using the secure cryptographic key shared between issuer system 140 and payment-network system 160, and cryptographic data 264 may include a copy of that shared cryptographic that is locally accessible to payment-network system 160. In some aspects, validation module 262 may obtain the secure cryptographic key from cryptographic data 264, and may perform operations that validate the digital signature, and thus the EPI, based on the secure cryptographic key.

In one aspect, if validation module 262 were unable to validate the digital signature (and thus, the EPI), payment-network system 160 may be unable to recognize executed payment service application 1026, and validation module 262 may perform operations identify an issuer of the Visa™ credit card based on portions of token 205 and transmit data indicative of the failed validation to issuer system 140. Alternatively, if validation module 262 were able to validate the digital signature (and thus, the EPI), payment-network system 160 may recognize and trust executed payment service application 102A, and validation module 262 may perform operations that authenticate the account data associated with the Visa™ credit card based on portions of token 205. For example, validation module 262 may perform account authentication processes that, based on token 205, establish that the account number, expiration date, and/or CSC of the Visa™ credit card are valid and properly formatted for processing by payment-network system 160, and further, are associated with a valid issuer identification number (IIN) linked to issuer system 140. In some instances, validation module 262 may generate data confirming the authenticity of the account data associated with the Visa™ credit card, e.g., confirmation 265, which payment-network system 160 may transmit across network 120 to device 102.

Account authentication module 206 of payment service application 102A may receive confirmation 265, and in certain aspects, may perform operations that process confirmation 265 and determine an outcome of the authentication of the account data associated with the Visa™ credit card (e.g., account data 203) by payment-network system 160. For example, if payment-network system 160 were unable to authenticate the account data, confirmation 265 may include data indicative of a failed authentication of the account data associated with the Visa™ credit card, and account authentication module 206 may perform operations that present a representation of the failed authentication to user 101 through the interface module, e.g., within the GUI described above. In other instances, if payment-network system 160 were to authenticate the account data, confirmation 265 may include data indicative of a successful authentication of the account data, and account authentication module 206 may perform operations that package 205 and cryptogram 247 (e.g., the EPI) into outcome data 209, which account authentication module 208 may provide to a provisioning module 210 of executed payment service application 102A.

In some aspects, and based on the successful authentication of the account data associated with the Visa™ credit card, provisioning module 210 may perform operations that provision the Visa™ credit card into the third-party digital wallet, which may render the Visa™ credit card available for use in transactions involving the third-party digital wallet. For example, to provision the Visa™ credit card into the third-party digital wallet, provisioning module may access data repository 104 (e.g., as maintained within one or more tangible, non-transitory memories of device 102), and store data indicative of token 205 and cryptogram 247 within a portion of data repository 104 that identifies payment instruments provisioned into the third-party digital wallet, e.g., digital wallet data 212. Additionally, in certain instances, provisioning module 210 may perform additional operations that link together the structured data records that correspond to token 205 and cryptogram 247, which may establish an availability of token 205, and the associated Visa™ credit card, for use in transactions involving the third-party digital wallet, which may be initiated by executed payment service application 102A.

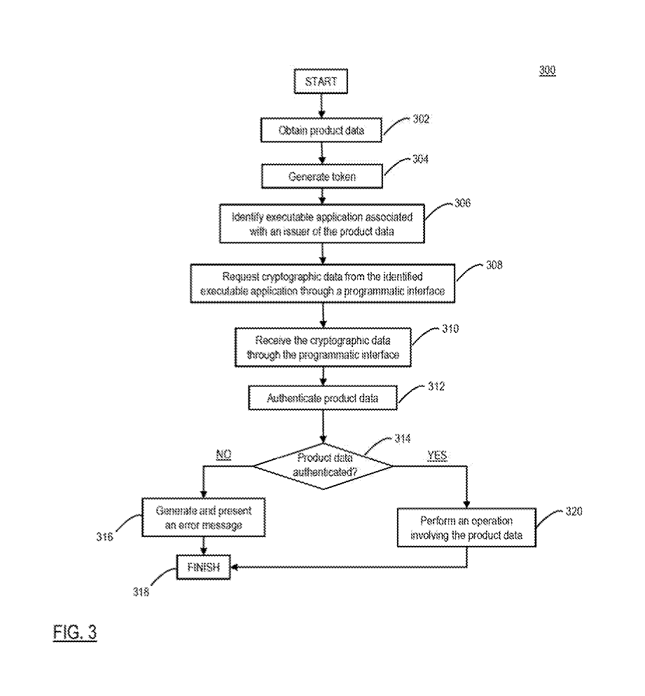

FIG. 3 is a flowchart of an example process 300 for authenticating product data obtained by an executed first application in real-time based on cryptographic data received from an executed second application, in accordance with the disclosed embodiments. In some aspects, the first executed application, such as payment service application 102A executed by device 102 of FIG. 1, may perform the steps of exemplary process 300. For example, and as described above, device 102 may execute payment services application 102A, which may cause device 102 to perform operations that maintain and establish a third-party digital wallet held by a user of device 102, e.g., user 101 of FIG. 1, and available for use in certain transactions, such as purchase transactions involving various merchants.

In some instances, as described below, device 102 may obtain product data, such as account data specifying a new payment instrument for provisioning to the third-party mobile wallet, and executed payment services application 102A may cause device 102 to request and obtain, from the executed second application (e.g., mobile banking application 1026 of FIG. 1) cryptographic data generated by a first computer system associated with the issuer of the product data (e.g., issuer system 140 of FIG. 1, which may be associated with a financial institution that issues the new payment instrument). Upon receipt of the cryptographic data, executed payment service application 102A may cause device 102 to perform processes that, in conjunction with a second computer system (e.g., payment-network computer system 160 of FIG. 1, which may settle transactions involving the new payment instrument), authenticate the obtained product data and provision the new payment instrument to the third-party digital wallet in real-time and without the delays associated with the out-of-band authentication processes described above.

Referring to FIG. 3, device 102 may obtain data identifying a product associated with an issuer (e.g., in step 302). In one aspect, the obtained product data may include account data that identifies and specifies a payment instrument held by user 101, such as a new Visa™ credit card that user 101 intends to include within the third-party digital wallet maintained on device 102 by the first executed application, e.g., executed payment service application 102A. By way of example, and as described above, the Visa™ credit card may be issued by a financial institution that provides or is associated with mobile banking application 102B, and a payment network associated with payment-network system 160, such as a Visa™ payment rail, may perform operations that process and settle initiated transactions involving the Visa™ credit card. As further described above, the third-party digital wallet established and maintained by executed payment service application 102A may be unrelated to the issuer of the Visa™ credit card or to the Visa™ payment rail, and thus, payment service application 102A may be unknown to and untrusted by payment-network system 160.

For example, payment service application 102A may, when executed by device 102, perform operations that generate a graphical user interface (GUI), which device 102 may present to user 101 through the corresponding interface module, such as a pressure-sensitive, touchscreen display. In some instances, the presented GUI may prompt user 101 to provide input that identifies the new payment instrument, e.g., the Visa™ credit card held by user 101, for provisioning into the third-party digital wallet, and further, that specifies certain account parameters of that new payment instrument, such as an account number, an expiration date, a card-security code (CSC), and a name and address of an account holder of the Visa™ credit card. In response to the presented GUI, user 101 may provide data that identifies and specifies the new Visa™ credit card, which device 102 may receive through the corresponding interface module in step 302.

In certain aspects, executed payment service application 102A may cause device 102 to process the obtained product data and generate a unique digital identifier, such as a token, representative of portions of the obtained product data (e.g., in step 304). For example, the generated token may replace or obscure sensitive portions of the obtained product data, such as the sixteen-digit account number, the expiration data, and/or the three-digit CSC of the Visa™ credit card held by user 101, with additional data known to or recognizable by issuer system 140 and/or payment-network system 160, and device 102 may generate the token representative of the obtained product data using any of the exemplary processes described above.

Based on portions of the obtained product data or the generated token, executed payment service application 102A may cause device 102 to identify a second application executable by device 102 and further, associated with or provided by the issuer of the product data (e.g., in step 306). For example, the new Visa™ credit card may be issued by a corresponding financial institution, and device 102 may access stored data identifying the executed second application, e.g., executed mobile banking application 102B, and based on the accessed data, establish an association between executed mobile banking application 102B the financial institution that issues the Visa™ credit card using any of the processes described above.

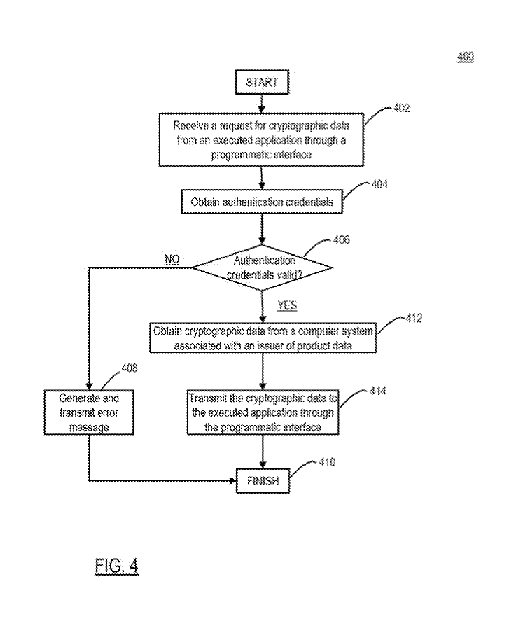

In additional aspects, payment service application 102A may, when executed by device 102A, generate a request for cryptographic data, and provide that generated request to mobile banking application 102B through a corresponding programmatic interface, such as API 222 of FIGS. 2A and 2B (e.g., in step 308). As described above, the requested cryptographic data may enable payment-network system 160 to identify executed payment service application 102A and establish a level of trust with executed payment service application 102A sufficient to authenticate the obtained product data in real-time, and without delays associated with the out-of-band authentication processes described above. In response to the received request, and based on its relationship with the issuer of the product data (e.g., the account data specifying the Visa™ credit card), mobile banking application 102B may perform operations that obtain the cryptographic data from issuer system 140 and return the obtained cryptographic data to executed payment service application 102A through the corresponding programmatic interface, as described below in reference to FIG. 4.

FIG. 4 is a flowchart of an exemplary process 400 for obtaining cryptographic data associated with an issuer of obtained product data, in accordance with the disclosed embodiments. In some aspects, a device executing an application associated with the issuer, e.g., device 102 executing mobile banking application 102B of FIG. 1, may perform the steps of exemplary process 400. For example, and as described above, mobile banking application 102B, when executed by device 102, may receive a request to obtain the cryptographic data from an additional application executed by device 102, e.g., payment service application 102A of FIG. 1, through a corresponding programmatic interface, such as API 222 of FIGS. 2A and 2B. In response to the received request, and as described below, executed mobile banking application 102B may cause device 102 to perform processes that validate authentication credentials associated with device 102, and poll a computer system associated with the issuer of the product data, e.g., issuer system 140 of FIG. 1, to obtain the cryptographic data, which may be provided to executed payment service application 102A through API 222.

Referring to FIG. 4, the executed application, e.g., executed mobile banking application 102B, may receive a request to obtain cryptographic data from the additional application executed by device 102, e.g., executed payment service application 102A, through the programmatic interface (e.g., in step 402). For example, and as described above, device 102 may receive product data, such as account data specifying a payment instrument for provisioning into a third-party digital wallet maintained by payment service application 102A on device 102, and the cryptographic data may facilitate a real-time authentication of the product data by executed payment service application 102A in conjunction with a computer system associated with a payment network that settles transactions involving the payment instrument, e.g., payment-network system 160 of FIG. 1.

In some aspects, and in response to the received request, executed mobile banking application 102B may cause device 102 to perform processes that obtain authentication credentials associated with device 102 (e.g., in step 404), and to validate the authentication credentials using any of the processes described above (e.g., in step 406). For example, the authentication credentials may include one or more of login credentials assigned to user 101 by mobile banking application 102B (e.g., an alpha-numeric user name or password, a biometric credential, etc.), and user 101 may provide input data specifying the authentication credentials to device 102 through a corresponding interface module, such as a pressure-sensitive, touchscreen display unit.

If device 102 were to establish an invalidity of the authentication credentials (e.g., step 406; NO), executed mobile banking application 102B may cause device 102 to generate an error message indicative of the failed authentication, which executed mobile banking application 102B may transmit to executed payment service application 102A through the programmatic interface (e.g., in step 408). Additionally or alternatively, executed mobile banking application 102B may also cause device 102 to present a representation of the generated error message to user 101 through the corresponding interface module. In certain instances, exemplary process 400 may then be complete in step 410.

Alternatively, if device 102 were to establish a validity of the authentication credentials (e.g., step 406; YES), executed mobile banking application 102B may cause device 102 to perform processes that obtain the cryptographic data from the computer system associated with the issuer of the product data, e.g., issuer system 140 (e.g., in step 412). By way of example, in step 412, executed mobile banking application 102B may perform operations that generate a request for the cryptographic data, which device 102 may transmit across network 120 to issuer system 140. In some aspects, the requested cryptographic data may facilitate a real-time authentication of the product data by executed payment service application 102A in conjunction with payment-network system 160, and issuer system 140 may perform any of the exemplary processes described above to generate the requested cryptographic data and provide the generated cryptographic data to executed mobile banking application 1026 in response to the request. In some aspects, and upon receipt of the cryptographic data from issuer system 140, executed mobile banking application 102B may route the received cryptographic data back to executed payment service application 102A through the programmatic interface (e.g., in step 414). Exemplary process 400 may then pass back to step 410, and exemplary process 400 may be complete.

Referring back to FIG. 3, payment service application 102A, when executed by device 102A, may receive the requested cryptographic data from executed mobile banking application 102B through the corresponding programmatic interface (e.g., in step 310). In some aspects, executed payment service application 102A may cause device 102 to perform any of the exemplary processes described above, in conjunction with payment-network system 160, to authenticate the obtained product data (e.g., the account data specifying the Visa™ credit card) for provisioning into the third-party digital wallet based on the cryptographic data (e.g., in step 312).

The cryptographic data may, in one instance, include a digitally signed cryptogram that enables payment-network system 160 to identify and trust payment service application 102A. For example, the digitally signed cryptogram may correspond to an encrypted payment instrument (EPI), which incorporates a digital signature generated by issuer system 140 using a secure cryptographic key known to both issuer system 140 and payment-network system 160. The disclosed embodiments are, however, not limited to these examples of digitally signed cryptograms or EPIs, and in other aspects, the received cryptographic data may include any additional or alternate cryptograms or tokens, such as those generated and/or digitally signed by issuer system 140, that enable payment-network system 160 to identify and trust payment service application 102A.

In certain aspects, and as described above, executed payment service application 102A may cause device 102 to perform processes in step 312 that generate a request to approve the received product data (e.g., an approval request) that include the generated token representative of the received product data and the received cryptographic data, which device 102 may across network 120 to payment-network system 160. Payment-network system 160 may, in some aspects, validate the cryptographic data included within the transmitted request to identify and establish trust with executed payment service application 102A, and perform any of the exemplary processes described above to authenticate the product data associated with the generated token and transmit data confirming an outcome of the authentication of the product data to device 102.

Referring back to FIG. 3, device 102 may receive the confirmation data from payment-network system 160, and executed payment service application 102A may cause device 102 to process the confirmation data and determine whether payment-network system 160 authenticated the product data for provisioning to the third-party digital wallet (e.g., in step 314). If device 102 were to determine that the confirmation data indicates a failed authentication of the product data (e.g., step 314; NO), executed payment service application 102A may cause device 102 to generate an error message indicative of the failed authentication, which device 102 may present to user 101 through the corresponding interface module (e.g., in step 316). Exemplary process 300 may then be complete in step 318.

Alternatively, if device 102 were to determine that the confirmation data indicates a successful authentication (e.g., step 314; YES), executed payment service application 102A may cause device 102 to perform an operation involving the product data (e.g., in step 320). For example, executed payment service application 102A may cause device 102 to perform any of the exemplary processes described above to provision the payment instrument, e.g., the Visa™ credit card, into the third-party digital wallet for use in transactions. Exemplary process 300 may then pass back to step 318, and exemplary process 300 may be complete.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification, including payment service application 102A and mobile banking application 102B, as well as data input module 202, token generation module 204, account authentication module 206, provisioning module 210, user authentication module 224, cryptogram retrieval module 226, authentication module 242, and cryptogram generation module 246, can be implemented as one or more computer programs, i.e., one or more modules of computer program instructions encoded on a tangible non-transitory program carrier for execution by, or to control the operation of, data processing apparatus.

Additionally or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “apparatus” or “system” refers to data processing hardware and encompasses all kinds of apparatus, devices, and machines for processing data, including by way of example a programmable processor, a computer, or multiple processors or computers. The apparatus or system can also be or further include special purpose logic circuitry, such as an FPGA (field programmable gate array) or an ASIC (application-specific integrated circuit). The apparatus or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computer system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computer system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A device, comprising:
a communications module;
a storage unit storing instructions; and
at least one processor coupled to the storage unit and the communications module, the at least processor being configured to execute the instructions to:
obtain data identifying a product;
in response to the obtained data, request cryptographic data from an application program executed by the at least one processor, the request being provided to the executed application program through a programmatic interface;
receive the cryptographic data from the executed application program through the programmatic interface, the cryptographic data being generated in response to a verification of authentication credentials associated with the device;
transmit, through the communications module, a request to authenticate the product data to a first computer system, the request comprising the product data and the cryptographic data, and the first computer system being configured to validate the cryptographic data and establish an authenticity of the product data;
receive, through the communications module, data from the first computer system that confirms the authenticity of the product data; and
in response to the data received from the first computer system, perform an operation involving the product data.

2. The device of claim 1, wherein:
the executed application program is associated with an issuer of the product;
a second computer system associated with the issuer is configured to generate the cryptographic data in response to the verification of the authentication credentials associated with the device; and
the cryptographic data comprises a digital signature of the second computer system.

3. The device of claim 2, wherein:
the second computer system is configured to generate the digital signature using a cryptographic key accessible to the first and second computer systems; and
the first computer system is further configured to validate the digital signature using the cryptographic key.

4. The device of claim 1, further comprising an interface module coupled to the at least one processor, the at least one processor being further configured to execute the instructions to receive the data identifying the product by receiving the data through the interface module.

5. The device of claim 1, wherein the at least one processor is further configured to execute the instructions to generate a digital token representative of a portion of the obtained product data.

6. The device of claim 5, wherein:
the request to authenticate the product data comprises the generated digital token; and
the first computer system is further configured to establish the authenticity of the product data based on the digital token.

7. The device of claim 5, wherein the at least one processor is further configured to provision the digital token to the device in response to the data received from the first computer system, the digital token being usable in transactions involving the product.

8. The device of claim 1, wherein:
the product comprises a payment instrument, the payment instrument being associated with an issuer of the product, and the payment instrument comprising a credit-card account, a debit-card account, a financial-services account, or an account associated with a digital currency;
the product data comprises account data that characterizes the payment instrument, the account data comprising an account number, an expiration date, a card security code, or account-holder data;
the first computer system is associated with a payment network that settles transactions involving the payment system; and
the first computer system is further configured to validate the cryptographic data and establish an authenticity of the account data.

9. The device of claim 8, wherein the at least one processor is further configured to execute the instructions to:
generate data establishing a digital wallet, the digital wallet being associated with a third party unrelated to the issuer or the payment network; and
in response to the data received from the first computer system, provision the payment instrument to the digital wallet, the provisioned payment instrument being usable in transactions involving the digital wallet.

10. The device of claim 8, wherein the cryptographic data comprises an encrypted payment instrument.

11. A computer-implemented method, comprising:
obtaining, by at least one processor, data identifying a product;
in response to the obtained data, requesting, by the at least one processor, cryptographic data from an application program executed by the at least one processor, the request being provided to the executed application program through a programmatic interface;
receiving, by the at least one processor, the cryptographic data from the executed application program through the programmatic interface, the cryptographic data being generated in response to a verification of authentication credentials associated with the device;
transmitting, through a communications module, and by the at least one processor, a request to authenticate the product data to a first computer system, the request comprising the product data and the cryptographic data, and the first computer system being configured to validate the cryptographic data and establish an authenticity of the product data;
receiving, through the communications module, and by the at least one processor, data from the first computer system that confirms the authenticity of the product data; and
in response to the data received from the first computer system, performing, by the at least one processor, an operation involving the product data.

12. The computer-implemented method of claim 11, further comprising generating a digital token representative of a portion of the obtained product data, wherein:
the request to authenticate the product data comprises the generated digital token;
the first computer system is further configured to establish the authenticity of the product data based on the digital token; and
the performing comprises performing operations that provision the digital token to the device in response to the received confirmation data, the digital token being usable in transactions involving the product.

13. The computer-implemented method of claim 12, wherein:
the executed application program is associated with an issuer of the product;
a second computer system associated with the issuer is configured to generate the cryptographic data in response to the verification of the authentication credentials associated with the device; and
the cryptographic data comprises a digital signature of the second computer system.

14. The computer-implemented method of claim 11, wherein:
the product comprises a payment instrument, the payment instrument being associated with an issuer of the product;
the product data comprises account data that characterizes the payment instrument; and
the second computer system is associated with a payment network that settles transactions involving the payment system.

15. The computer-implemented method of claim 11, further comprising:
generating data establishing a digital wallet, the digital wallet being associated with a third party unrelated to the issuer or the payment network; and
in response to the confirmation data, performing operations that provision the payment instrument to the digital wallet, the provisioned payment instrument being usable in transactions involving the digital wallet.

16. A device, comprising:
a communications module;
a storage unit storing instructions; and
at least one processor coupled to the storage unit and the communications module, the at least processor being configured to execute the instructions to:
receive, through a programmatic interface, a request for cryptographic data from an application program executed by the at least one processor;
perform operations that verify authentication credentials associated with the device;
in response to the verification of the authentication credentials, obtain cryptographic comprising a digital signature of a first computer system; and
provide the cryptographic data to the executed application program through the programmatic interface, the executed application program causing the device to transmit the cryptographic data to a second computer system as a request to authenticate data identifying the product, the second computer system being configured to validate the cryptographic data and establish an authenticity of the product data.

17. The device of claim 16, further comprising an interface module coupled to the at least one processor, the at least one processor being further configured to execute the instructions to:
receive the data identifying authentication credentials by receiving the data through the interface module;
transmit, through the communications module, the data identifying the authentication credentials to the first computer system, the first computer system being configured to verify the authentication credentials; and
receive, through the communications module, data confirming the verification of the authentication credentials from the first computer system.

18. The device of claim 16, wherein:
the executed application program is associated with a product; and
the at least one processor is further configured to execute the instructions to obtain the cryptographic data from the first computer system, the first computer system being associated with an issuer of the product.

19. The device of claim 18, wherein:
the product comprises a payment instrument, the payment instrument being associated with the issuer;
the product data comprises account data that characterizes the payment instrument; and
the second computer system is associated with a payment network that settles transactions involving the payment system.

20. The device of claim 16, wherein the cryptographic data comprises an encrypted payment instrument.
